(19) United States
(12) Patent Application Publication
(10) Pub. No.: US 2004/0183462 A1
(43) Pub. Date: Sep. 23, 2004

(54) Control circuit for signal lamps of a vehicle

(76) Inventors: Markus Frank, Backnang (DE); Siegfried Kolb, Winnenden (DE); Armin Staehle, Nufringen (DE); Kurt Wilfinger, Aidlingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/743,842

(22) Filed: Dec. 22, 2003

(30) Foreign Application Priority Data
Dec. 23, 2002 (DE) 102 60 796.6

(51) Int. Cl. H05B 37/02

(52) U.S. Cl. 315/219

(57) ABSTRACT

A control device for signal lamps of a vehicle, having a signalling circuit for generating an intermittent signal current as load current for the signal lamps, and a signal switch for activating the signalling circuit. The control device, which can be implemented easily, generates a running light function for signal lamps of a vehicle. A clock circuit is provided which drives the load current of at least two signal lamps individually in each case with the aid of a prescribed clock sequence, in which case, acting as operating voltage source for this clock circuit, the signalling circuit feeds the latter the intermittent signal current. The control device can be used both in the context of a turn flasher and hazard warning function and for signalling the state of central locking or antitheft warning systems, and merely for controlling electroluminescence luminous strips with the aim of enhancing the overall visual impression of a vehicle.

### CROSS-REFERENCE TO A RELATED APPLICATION

This application claims the benefit of the filing date of German Patent Application Serial No. 102 60 796.6, filed on Dec. 23, 2002.

### BACKGROUND AND SUMMARY OF THE INVENTION

The invention relates to a control circuit for signal lamps of a vehicle.

Such a control circuit is known from German reference DE 43 34 371 A1, being designed as a turn flasher and hazard warning system for motor vehicles, and comprising a load-controlled flasher circuit, a hazard warning switch and a turn flasher switch. Such a load-controlled control device functions in such a way that a flasher relay switch assigned to the flasher circuit is open in the rest state such that upon actuation of the turn signal switch firstly only a small current flows into the flasher lamps via a high-resistance resistor connected in parallel with a switching bridge of the flasher relay, with the result that this current is detected by the signalling circuit and thereupon initiates clocked driving of the flasher relay such that the switching bridge thereof short circuits the high-resistance resistor, and the flasher lamps are supplied intermittently with the signal current as load current.

Also known, apart from this are hazard warning systems based on another functional principle such as described, for example, in German reference DE 40 30 513 A1. With this principle, each flasher lamp group to be driven is respectively controlled intermittently by a control device using a dedicated load circuit relay.

The flasher lamps used to indicate driving direction are fitted at different points on the vehicle, for example in the front region of the bumper, in the rear region of the bumper or else in the region of the rear mirror, it being possible in each case for a plurality of series-connected flasher lamps to be combined to form a group, as is described in German reference DE 199 06 988 A1, for example.

It is known, furthermore, from German reference DE-U 16 79 089 to design the flasher display on a vehicle as a running light. This known direction indicator comprises a number of incandescent lamps which are arranged in the region of the front and rear bumpers and are driven in such a way that a moving line or arrow is produced in the direction of indication. The use of a running light for indicating direction is also known from German reference DE 200 08 994 U1, where the flasher lamps are arranged sloping downwards as warning beacons on the rear side of the rear view mirror.

For the sake of completeness, reference may also be made to German reference DE 197 45 993 A1, which describes the use of electroluminescent luminous strips on the outer skin of a vehicle, and can be driven such that a running light is likewise produced thereby. These known luminous strips serve, on the one hand, to configure the vehicle body visually and to display specific vehicle states such as, for example, direction when travelling forwards or backwards, or to display the state of the central locking or antitheft systems.

The object of the invention consists in specifying a control device, which is easy to implement, of the type mentioned at the beginning for the purpose of producing a prescribable light pattern, in particular a running light.

This object is achieved by means of a clock circuit which controls the load current of at least two signal lamps individually in each case with the aid of a prescribed clock sequence, and acting as operating voltage source for the clock circuit the signalling circuit feeds the latter the intermittent signal current generated. Each individual signal lamp is thereby driven separately with the aid of a prescribed clock sequence, synchronization with the remaining flasher lamp groups being ensured on the basis of the voltage supply of the clock circuit via the signalling circuit. Each individual signal lamp is thereby driven individually only during the flasher pulses.

If the signal lamps combined as a flasher lamp group are arranged on a printed board, this clock circuit according to the invention can be arranged on this printed board in a simple way, there being no consequent need to change the interface to the signalling circuit, and retrofitting thereby being possible.

In an advantageous development, the clock circuit according to the invention is designed as a microcontroller, such that it is thereby possible in a simple way to drive each signal lamp with the aid of each desired clock sequence in order thereby to produce a desired light pattern or to achieve any desired running light effect.

Each signal lamp is preferably controlled via an output stage circuit which, for its part, is connected to the control outputs of the microcontroller. In this case, these output stage circuits can be designed either as low-side switches, as a consequence of which each signal lamp must also be connected to the signalling circuit for feeding the intermittent signal current, or they can constitute a high-side switch, the intermittent signal current requiring to be fed to the high-side switch in this case.

In order to implement a running light effect, at least two signal lamps are required, while plurality of, at least four or five, signal lamps are to be provided for a detectable running light effect.

In a further advantageous refinement of the invention, the signalling circuit is designed as a flasher circuit, and the signal switch is designed as a turn flasher switch. Moreover, a further signal switch can be provided as hazard warning switch. It is thereby possible to implement a running light control for mirror-mounted flashers in a simple way. Finally, the control circuit according to the invention can advantageously be operated in such a way that a further clock sequence is superimposed on the prescribed clock sequence during the light phase of the signal lamps by subjecting the load current to pulse width modulation in this phase. Thus, the brightness of each signal lamp can be specifically controlled. The light/dark transitions can be better adapted when, in particular, use is made of light-emitting diodes (LEDs), which have a short afterglow persistence.

### BRIEF DESCRIPTION OF THE DRAWING

The method according to the invention is to be explained and illustrated below with the aid of exemplary embodiments in conjunction with the figures in which:

FIG. 1 shows a block diagram of a first exemplary embodiment of the control device according to the invention as a turn flasher and hazard warning system for a motor vehicle,

FIG. 2 shows a block diagram of a second exemplary embodiment of the control circuit according to the invention,

FIG. 3 shows a circuit arrangement of the output stages using low-side switches,

FIG. 4 shows a circuit arrangement of output stage circuits using high-side switches,

FIG. 5 shows a sectional illustration of a rear-view mirror with signal lamps to be driven according to the invention,

FIG. 6 shows pulse diagrams illustrating by way of example a clock sequence for driving the signal lamps shown in FIG. 5, and

FIG. 7 shows an example of a lamp sequence for signal lamps illustrated in FIG. 5.

### DETAILED DESCRIPTION OF THE DRAWING

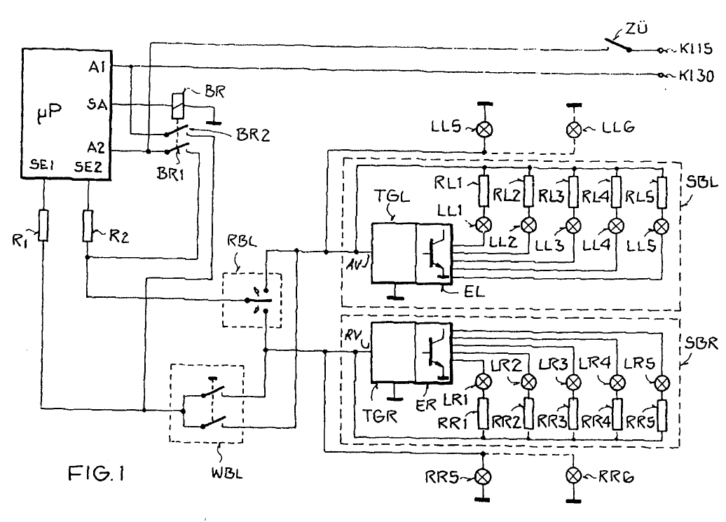

FIG. 1 shows the circuit diagram of a turn flasher and hazard warning system having a load-controlled flasher unit which is designed as a microprocessor μP and drives a flasher relay BR via an output SA. The voltage is supplied on the one hand by the terminal 15 (KL 15) via an ignition switch ZÜ to a connection of the microprocessor A2, and via a connection A1 to the terminal 30 (KL30). The switching bridge BR1 of the flasher relay BR connects the terminal A2 of the microprocessor μP to the changeover contact of the turn flasher switch RBL, which is designed as a two-way make contact with a neutral centre position and whose two fixed contacts are connected respectively to the left-hand or right-hand flasher-lamp groups SBL, LL5 and LL6 or SBR, RR5 and RR6. The connecting point of the switching bridge BR1 with the turn flasher switch RBL is connected via a measuring shunt R2 to a signal input SE2 of the microprocessor μP. A further signal input SE1 of the microprocessor μP is connected via a further measuring shunt R1 to a hazard warning switch WBL on the one hand, and, by a second switching bridge BR of the flasher relay BR, to the connection A1, on the other hand. The said left-hand and right-hand flasher lamp groups are connected upon actuation of the hazard warning switch WBL.

The flasher lamp groups SBL and SBR constitute a left-hand and right-hand mirror-mounted flasher, respectively, which include signal lamps LL1 to LL5 and LR1 to LR5 with series resistors RL1 to RL5 or RR1 to RR5 connected in each case in series with the individual signal lamps. Each signal lamp LL1 to LL5 or LR1 to LR5 is connected to an output stage EL and ER, respectively, which for their part are driven individually with a prescribed clock sequence by a clock circuit TGL or TGR designed as a microcontroller. In addition to the flasher lamp groups LL5 and LL6, the series resistors RL1 to RL5, these series resistors RL1 to RL5 are also for the voltage supply of the microcontroller TGL, the voltage supply input AV of the latter is also connected to one of the fixed contacts of the turn flasher switch RBL for feeding a flasher signal current I_{BL}. A corresponding statement also holds for the right-hand flasher lamp groups RR5 and RR6, as well as the series resistors RR1 to RR5 and the voltage supply input RV of the microcontroller TGR of the right-hand mirror-mounted flasher SBR. Upon actuation of the turn flasher switch RBL, the selected flasher lamp groups, for example LL5, LL6, and the left-hand mirror-mounted flasher SBL are connected via the measuring shunt R2 to the signal input SE2 of the microprocessor μP, as a consequence of which the measuring voltage produced at this measuring shunt causes the microprocessor μP to drive the flasher relay BR via the signal output SA intermittently as long as the voltage drop across the measuring shunt R2 is detected. A corresponding pulse diagram is shown in the first t-I_{BL} diagram of FIG. 6. In accordance with such a clock sequence, the switching bridge BR1 of the flasher relay BR is closed and a corresponding flasher signal current I_{BL} is fed to the flasher lamp groups LL5 and LL6, as well as to the left-hand mirror-mounted flasher SBL. Consequently, both the signal lamps LL1 to LL5 are supplied with a load current, and the microcontroller TGL is switched on and off in step with this flasher signal current I_{BL}. In the switched-on state, that is to say during a pulse of the flasher signal current I_{BL} the latter drives the output stage EL1 to EL5 respectively assigned to each signal lamp LL1 to LL5, as illustrated by way of example in FIG. 3. Each of these output stages EL1 to EL5 comprises a low-side switch that is constructed as a transistor element T_{EL1} to T_{EL5} with in each case an emitter resistor R_{EL1} to R_{EL5} connected to frame. The load current of each signal lamp LLᵢ, i=1, . . . 5 is thereby clocked in a starting phase of the microcontroller TGL in accordance with a programmed clock sequence. The voltage supply of the microcontroller TGL via the flasher relay BR, ensures the synchronization with the other flasher lamp groups LL5 and LL6.

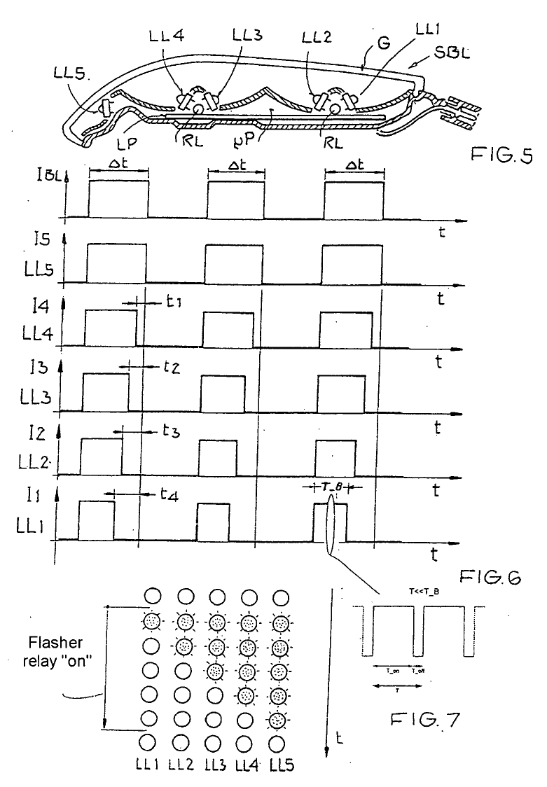

An example of individual driving of the signal lamps LL1 to LL5 or RR1 to RR5 of the mirror-mounted flasher SBL or SBR is shown by the pulse diagrams of FIG. 6. The first t-I_{BL} pulse diagram shows the flasher signal current I_{BL} generated by the flasher relay BR, its pulse duration being denoted by At. The further pulse diagrams respectively show the load current clocked for each signal lamp LL1 to LL5, that is to say the t-I₅ diagram shows the load current for the signal lamp LL5, the t-I₄ diagram shows the load current for the signal lamp LL4, the t-I₃ diagram shows the load current for the signal lamp LL3, the t-I₂ diagram shows the load current for the signal lamp LL2, and, finally, the t-I₁ diagram shows the load current for the signal lamp LL1. It may be seen from the last mentioned four pulse diagrams that the pulse duration for the signal lamps LL4, LL3, LL2 and LL1 is shortened in each case by an increasing time duration t1 to t4. The result for the signal lamps LL1 to LL5 is an appearance in accordance with which firstly all five signal lamps are switched on simultaneously within one flashing phase, whereas they are successively switched off towards the end of this flashing phase. This appearance is shown once again in another illustration by FIG. 7, in which it may be seen that the signal lamp LL5 is switched on during the entire “on” flasher phase in order, for example, to comply with statutory regulations such as synchronicity with other flashing lamps. It is also possible to ensure the brightness required by statute, because in the first flashing phase all signal lamps are switched on and also, if appropriate, the different images in the individual flashing phases can be shown for different lengths of time by appropriate programming of the microcontroller TGL.

In addition, it is also possible to exert fine control on the brightness of the signal lamps by superimposing a further clock sequence on the prescribed clock sequence by subjecting the load current of the signal lamps to pulse width modulation during the bright phase. This is shown by way of example in the last pulse diagram (t-I₁ diagram) of FIG. 6 in an enlarged detail. Over the course of the bright phase T_B, the load current is subjected to pulse width modulation with a pulse length T which is very small by comparison with the bright phase T_B (T<<T_B), the on phase being T_on and the off phase being T_off. The light/dark transitions can be visually improved by using light-emitting diodes (LEDs), which have a low afterglow persistence.

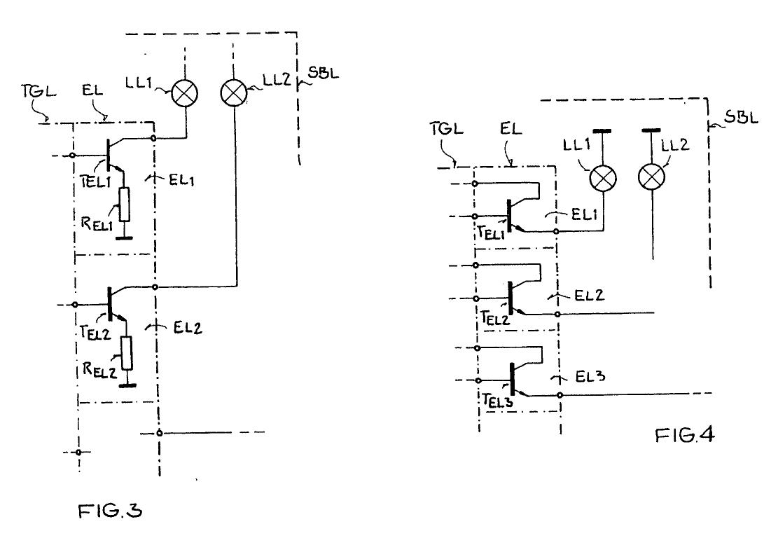

The output stages ELi, i=1, . . . 5 shown in FIG. 3 can also be constructed as high-side switches, as is shown in FIG. 4. There, the signal lamps are connected by one terminal to a frame potential, and are connected by the other connection via a transistor switch designed as output stage. Consequently, each output stage EL1 to EL5 includes a switching transistor T_{Eli}, i=1 whose emitter electrode is fed to the output of the output stage, whose collector electrode is fed a load current proportional to the flasher signal current I_{BL}, and to whose base electrode a control signal generated by the microcontroller TGL is applied.

Upon actuation of the hazard warning switch WBL in accordance with FIG. 1, both the left-hand and the right-hand flasher lamp groups LL5, LL6 and SBL or RR5, RR6 and SBR are connected via the measuring shunt R1 to a signal input SE1 of the microprocessor μP as a result of which a voltage drop is generated across this measuring shunt R1. Upon detection of such a voltage drop, the flasher relay BR is driven intermittently via the output SA of the microprocessor μP such that the said flasher lamp groups are connected in step with this drive signal to the terminal 30 (KL30) via the switching bridge BR2 of the flasher relay BR as long as this hazard warning switch WBL remains actuated. In this hazard warning mode, as well, the signal lamps of the mirror-mounted flashers SBL and SBR are individually clocked during the flashing phases in accordance with the programming of the microcontrollers TGL and TGR, as was explained, for example, in conjunction with FIGS. 6 and 7.

In the case of the exemplary embodiment in accordance with FIG. 1, the left-hand flasher lamp groups LL5 and LL6 as well as the right-hand flasher lamp groups RR5 and RR6 can be arranged in each case at the front and rear end of the vehicle.

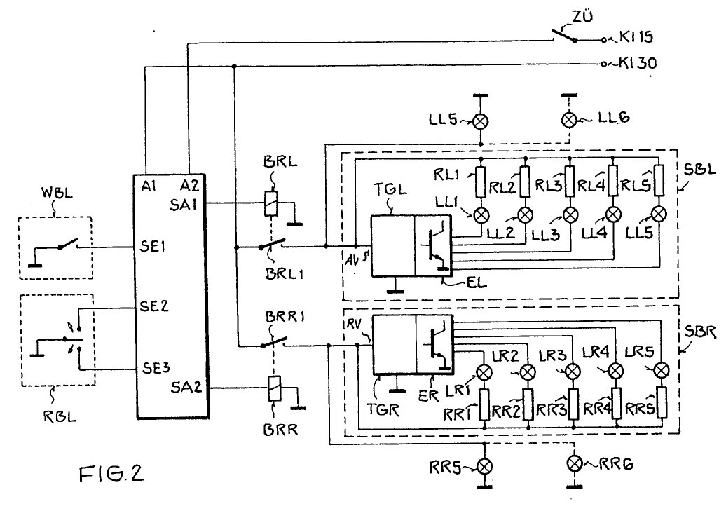

FIG. 2 shows a block diagram of a further exemplary embodiment of a control device according to the invention in the case of which, by contrast with the load control used in FIG. 1, a load switching relay BRL or BRR, provided respectively for the left-hand and right-hand flasher lamp groups, is controlled intermittently by a microprocessor μP as a function of the position of a turn flasher switch RBL or a hazard warning switch WBL. For this purpose, the microprocessor μP in accordance with FIG. 2 has a control input SE1 to which a hazard warning switch WBL is connected, for two further signal inputs SE2 and SE3 are connected to a turn flasher switch RBL. Two load switching relays BRL and BRR are connected for the purpose of intermittent driving to a control output SA1 or SA2. Two connections A1 and A2 of the microprocessor μP are connected via an ignition switch ZÜ to the terminal 15 (KL15) or the terminal 30 (KL30).

In the turn flashing mode, either the load switching relay BRL or BRR is driven intermittently such that in each case the driven flasher lamp groups are connected to the terminal 30 via the associated switching bridge BRL1 or BRR1 in step with this control signal for generating a corresponding flasher signal current.

The left-hand and right-hand flasher lamp groups LL5, LL6 and SBL as well as RR5, RR6 and SBR illustrated correspond to those in accordance with FIG. 1, the microcontroller TGL and TGR of, respectively, the left-hand and right-hand mirror-mounted flashers SBL and SBR have output stages whose design corresponds to the circuit according to FIG. 3.

Furthermore, these output stages EL and ER can be designed in accordance with FIG. 4 with high-side switches, the signal lamps also requiring to be connected in accordance with this figure.

FIG. 5 shows the mechanical design of a left-hand mirror-mounted flasher SBL, although it shows only a printed circuit board LP on which there are arranged signal lamps LL1 to LL5 and a corresponding transparent cover G, as well as associated carrier elements. The signal lamps LL1 to LL5 arranged on the printed circuit board LP are designed as light-emitting diodes (LEDs), the associated series resistors RL also being indicated in outline. Finally, the printed circuit board LP also carries the clock circuit, designed according to the invention as a microcontroller μC, and so there are no changes to the geometry by comparison with a conventional mirror-mounted flasher. There is no need either to make any changes to the interface of the vehicle. Consequently, such a mirror-mounted flasher according to the invention can also be designed as a retrofit solution without changes to the vehicle.

The light-emitting diodes used in this mirror-mounted flasher SBL can also be replaced by conventional incandescent bulbs.

The inventive control device for signal lamps of a vehicle for producing a predetermined luminous pattern and/or running light can, of course, be used not only in the case of a turn flasher and hazard warning function, but also to display the state of the central locking or antitheft warning system, as well as to display direction during driving manoeuvres such as, for example, when manoeuvring for entering or leaving a parking space. The inventive control device can even be used to drive electroluminescent luminous strips for the visual enhancement of vehicles.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A control device for signal lamps of a vehicle, comprising
a) a signalling circuit for generating an intermittent signal current as load current for the signal lamps, and
b) a signal switch for activating the signalling circuit, wherein:
c) a clock circuit is provided which controls the load current of at least two signal lamps individually in each case with the aid of a prescribed clock sequence, and
d) acting as an operating voltage source for the clock circuit, the signalling circuit feeds the clock circuit the intermittent signal current.

2. The control device according to claim 1, wherein the clock circuit is designed as a microcontroller, and a clock sequence can be programmed for each signal lamp to be driven by the microcontroller.

3. The control device according to claim 2, wherein the purpose of being driven with the aid of the prescribed clock sequence each signal lamp is connected to an output stage circuit, and these output stage circuits are driven via the control outputs of the microcontroller.

4. The control device according to claim 3, wherein the output stage circuits are designed as low-side switches, each signal lamp being connected, on the one hand, to the associated output stage circuit and, on the other hand, via a series resistor to the signalling circuit for the purpose of feeding the intermittent signal current.

5. The control device according to claim 3, wherein the output stage circuits are designed as high-side switches, each signal lamp being connected, on the one hand, to the associated output stage circuit and, on the other hand, to the reference potential of the control circuit.

6. The control device according to claim 1, wherein the clock sequences prescribed for the respective load current of the signal lamps lead to a running light effect in the case of the signal lamps driven by the clock circuit.

7. The control device according to claim 1 wherein the signalling circuit is designed as a flasher circuit, and the signal switch is designed as a turn flasher switch.

8. The control device according to claim 7, wherein a further signal switch is designed as a hazard warning switch.

9. A method for operating the control device according to claim 1, in which the load current, clocked by the prescribed clock sequence, of the signal lamps is pulse-width-modulated during the time of their bright phase.

10. Use of the control device according to claim 1 for a mirror-mounted flasher having a plurality of signal lamps in the case of which the clock circuit is also arranged on a carrier board in addition to the signal lamps.

11. A vehicle lighting system, comprising:
a first switching element;
a first control device to generate a first signal in response to a state of said first switching element;
an electroluminescent device; and
a second control device to generate a second signal for driving said electroluminescent device in response to said first signal.

12. The vehicle lighting system of claim 11, wherein said first switching element comprises a one-pole-two-throw switch used to -selectively indicate a direction of turning of a vehicle.

13. The vehicle lighting system of claim 12, wherein said electroluminescent device comprises a left-turn-indicating electroluminescent device and a right-turn indicating electroluminescent.

14. The vehicle lighting system of claim 11, wherein said first switching element comprises a two-pole-two-throw switch used to selectively indicate a hazard situation related to a vehicle.

15. The vehicle lighting system of claim 14, wherein said electroluminescent device comprises a first hazard-indicating electroluminescent device and a second hazard-indicating electroluminescent device.

16. The vehicle lighting system of claim 11, wherein said first control device comprises a microprocessor.

17. The vehicle lighting system of claim 11, wherein said first signal is substantially periodic.

18. The vehicle lighting system of claim 11, wherein said electroluminescent device comprises a light-emitting diode (LED).

19. The vehicle lighting system of claim 11, wherein said electroluminescent device comprises an incandescent device.

20. The vehicle lighting system of claim 11, wherein said second control device comprises a microcontroller.

21. The vehicle lighting system of claim 11, wherein said electroluminescent device comprises a plurality of electroluminescent devices, and wherein said second signal drives said plurality of electroluminescent devices in a predetermined time pattern.

22. The vehicle lighting system of claim 11, wherein said second control device pulse-width-modulates said second signal to control a brightness of said electroluminescent device.

23. A method of activating a vehicle lighting system, comprising:
generating a first signal in response to a state of a first switching element;
generating a second signal in response to said first signal; and
activating an electroluminescent device using said second signal.

24. The method of claim 23, wherein said electroluminescent device is used to indicate that a vehicle is turning left or right.

25. The method of claim 23, wherein said electroluminescent device is used to indicate a hazard condition related to a vehicle.

26. The method of claim 23, wherein said first signal is substantially periodic.

27. The method of claim 23, wherein said electroluminescent device comprises a plurality of electroluminescent devices, and wherein said second signal drives said plurality of electroluminescent devices in a predetermined pattern.

28. The method of claim 23, further comprising modulating said second signal to control a brightness of said electroluminescent device.

29. The method of claim 28, wherein modulating said second signal comprises pulse-width modulating said second signal.
